(19) United States
(12) Patent Application Publication
(10) Pub. No.: US 2010/0190030 A1
(43) Pub. Date: Jul. 29, 2010

(54) JOINING METHOD AND COMPOSITE OF AT LEAST TWO JOINING PARTNERS

(76) Inventors: Reiner Ramsayer, Schwieberdingen (DE); Jens Ackermann, Stuttgart (DE)

Correspondence Address: KENYON & KENYON LLP, ONE BROADWAY, NEW YORK, NY, 10004, US

(21) Appl. No.: 12/452,761

(22) PCT Filed: Jul. 4, 2008
(86) PCT No.: PCT/EP2008/058647

§ 371 Date: Apr. 5, 2010

(30) Foreign Application Priority Data
Jul. 25, 2007 (DE) 10 2007 034 609.5

(51) Int. Cl. B32B 9/00; B29C 65/02

(52) U.S. Cl. 428/688; 156/89.11

(57) ABSTRACT

A method for joining at least one first ceramic joining partner with at least one second joining partner includes: depositing at least one preceramic polymer on the first and/or the second joining partner in a joining region, bringing together the joining partners in the joining region, and heating the joining region such that the preceramic polymer transforms into an amorphous and/or crystalline ceramic that connects the joining partners to each other.

### BACKGROUND OF THE INVENTION

1. Field of the Invention

The present invention relates to a joining method using a preceramic polymer, and also relates to a composite of at least two joining partners.

2. Description of the Related Art

The joining of ceramic materials (of the same type or of different types) among themselves and the joining of a ceramic joining partner with a joining partner made of a non-ceramic material, such as a metallic material, has always been problematic. Normally, form-locking connections are ruled out due to the brittleness of ceramic. Presently, only a few methods are known for producing connections with at least one ceramic joining partner. For example, the related art includes the use of metallic soldering or glass soldering. Direct molten joining is also used, but is limited to very specific ceramic material groups. Typical process temperatures for molten joining of at least one ceramic joining partner with another joining partner or for melting glass solder or metallic solder are typically in a range between approximately 900° C. and approximately 1600° C. If such methods, which are still the subject of research and to the applicant's knowledge have not yet established themselves as production-ready manufacturing methods, are used to produce hermetically sealed sensor units, for example, then the required high temperatures are hardly implementable, since possibly installed electronic components or associated add-on parts of the joining partners would not withstand these high temperatures. In the event that a ceramic joining partner is joined with a metallic joining partner, the high process temperatures required are additionally harmful due to the different thermal expansion coefficients of metal and ceramic, since these may result in high tensions during heating and cooling and consequently in cracks in the ceramic joining partners.

Accordingly, there is a need for a joining method by which two ceramics of the same type or of different types, or a ceramic joining partner having a joining partner made of a non-ceramic material, such as a metal, may be joined, it being necessary for the method to ensure that add-on parts, electronic components, etc., situated in the area surrounding the joint are not, or only negligibly, influenced or even damaged.

### BRIEF SUMMARY OF THE INVENTION

An objective of the present invention is to provide an alternative joining method for joining a ceramic joining partner with at least one second joining partner, the joining method making it possible to connect the joining partners preferably already at process temperatures below 1000° C. Furthermore, an objective of the present invention is to provide an accordingly improved composite of at least two joining partners.

The present invention is based on the idea of joining a ceramic joining partner with at least one second joining partner, which may be a ceramic material of the same type or of a different type, and/or a non-ceramic material, such as metal, in particular, using at least one pre-ceramic polymer (precursor), which is deposited in a (subsequent) joining region of the at least two joining partners and is heated to a joining temperature at which the preceramic polymer transforms into an amorphous and/or crystalline ceramic that connects the joining partners to each other firmly. The scope of the present invention includes initially bringing together the joining partners and only subsequently introducing the at least one preceramic polymer into the joining region between the joining partners, or also initially depositing the preceramic polymer in the subsequent joining region on at least one of the joining partners and subsequently applying the joining partners onto each other or pressing the joining partners against each other in the joining region. In the sense of the present invention “bringing together” does not necessarily mean a contacting of the joining partners, since if the preceramic polymer was previously deposited, it is situated between the joining partners. In this case, “bringing together” instead achieves a sandwich structure having two outer joining partners and a preceramic polymer situated between them.

The at least one preceramic polymer may be deposited by spraying, dipping, printing, sprinkling, etc., depending on the state of the preceramic polymer. By using the joining method designed according to the concept of the present invention, a composite of at least two joining partners is obtained, of which at least one joining partner is made up of a ceramic material. The composite is characterized in that the joining partners are connected to each other in a joining region via an amorphous and/or crystalline ceramic, this ceramic having been produced by heating a preceramic polymer.

A chemical cross-linkage of the preceramic polymer occurs as a function of the state and/or the composition of the utilized at least one preceramic polymer when it is heated in a temperature range typically between approximately 120° C. and 300° C. Further heating, typically to a temperature from a temperature range between approximately 300° C. and approximately 800° C., pyrolyzes the polymers, in particular when organic groups split, and an amorphous ceramic forms, which is connected to the joining partners in a fatigue-resistant manner. In terms of its properties, the developing ceramic is typically nearly comparable to a crystalline and monolithic ceramic, so that the field of application of the compound obtained is also comparable to that of crystalline and monolithic ceramics, with regard to the temperature. The present invention optionally includes heating the amorphous ceramic further, in particular to a temperature from a range between approximately 1200° C. and approximately 1500° C., in order to transform it into a crystalline ceramic. The scope of the present invention also includes heating the joining region directly, i.e., without temperature rests, to approximately 300° C. to 800° C. or directly to between approximately 1200° C. to approximately 1500° C. The cross-linking density of the preceramic polymer may be used to optimize and adapt its properties, its viscosity, for example, such that the polymer is optimally adapted for the joining process.

When using preceramic polymers, it is particularly advantageous that they already at least partially cross-link at very low temperatures of below 300° C., which causes the joining region (joint) itself to stabilize against deformation during the joining process. This allows for a robust process management, since it is possible to omit elaborate clamping techniques.

Presently, preceramic polymers are known only for coating metallic components, in particular. With regard to possible preceramic polymers that may be used for the method according to the present invention, via which a composite of at least two joining partners according to the present invention may be obtained, reference is made to the following publications:

Motz, G., et. al.: Design of SiCN—Precursors for various applications, in: Ceramic Materials and Components for Engines, Wiley-VCH, p. 581-p. 585; and

Geiger, M.: Generation of ceramic coatings by laser pyrolysis of organo-metallic polymers, in: Conference Proceeding of 1^{st} Int. Conf. on “THE” Coatings in Manufacturing Engineering, Oct. 14-15, 1999, Thessaloniki, Greece, p. 333-p. 341

The method according to the present invention makes it possible, for the first time, to produce hybrid composites of metals and ceramics, which until now were not technically implementable. Furthermore, hermetically sealed structural components may be joined without damaging electronic component parts integrated in them and/or damaging the ceramic. Moreover, impervious connections of high thermal and mechanical strength may be formed between ceramics of the same type or of different types, as well as between ceramics and metals or ceramics and other types of materials. Furthermore, the method according to the present invention makes it possible to produce three-dimensional substrates and thus to increase the integration density. For example, three-dimensional substrates produced according to the present invention may be used when designing electronic modules, in particular to increase the integration density in chip packaging.

At this point, composites made of ZrO₂ and Al₂0₃ are mentioned as examples of possible connections of ceramic joining partners of different types, in particular for ceramic sensors.

A refinement of the present invention advantageously provides for the joining region, in particular, the preceramic polymer situated in the joining region, to be heated to a temperature from a range between approximately 300° C. and approximately 800° C. in order to obtain an amorphous ceramic. The stability of this amorphous ceramic is sufficient for most applications, so that a stable connection between a ceramic joining partner and at least one additional joining partner may be obtained even using the relatively low temperatures mentioned already, in particular in order to avoid negatively influencing or even damaging add-on parts and/or electronic components of at least one of the joining partners.

For some applications, it may be advantageous to heat the joining region, that is, the at least one preceramic polymer, to a temperature from a range between approximately 1200° C. and approximately 1500° C., in order to obtain a crystalline, in particular monolithic, ceramic having a corresponding stability.

Particularly good joining results were achieved by using polysilazanes as preceramic polymers. The use of chlorosilanes and/or polytitanosilazanes is particularly advantageous. It is particularly preferable to use modified preceramic polymers, in particular preceramic polymers that were modified with the aid of organo-metallic compounds, such as Ti(NR₂)₄, for example.

The scope of the present invention includes heating the joining region in a kiln process, that is, heating the joining partners and the preceramic polymer between them together in a kiln. However, it is fundamentally more advantageous, in particular for the protection of add-on parts and/or electronic components, to heat the joining region only locally such that the thermal energy is preferably introduced only in the region of the joining region, which means that essentially only the preceramic polymer and its immediate surroundings are heated. Preferably, the heating is carried out in a temperature-controlled manner, in particular using a pyrometer, in order to obtain optimum joining results and to keep the thermal load of the joining partners and their component parts as low as possible.

Laser radiation is advantageously used for merely locally heating the preceramic polymer of the subsequent composite of at least two joining partners, in order to start the pyrolysis process. As a result, the surroundings of the joint remain thermally almost unstressed in comparison with the known joining methods. Furthermore, by using laser radiation to heat the joining region, the temperature input in the preceramic polymer may be optimized in a targeted manner through a suitable selection of the laser radiation wavelength. Furthermore, laser radiation guidance components, such as a laser scanner, for example, may be used to produce almost any joining contour. An additional advantage of using a laser scanner is that the quick movement of the laser beam focus allows for the heat to be input virtually simultaneously in the entire joining region, which means that it is possible to achieve a heat input that is homogenous on the whole while avoiding temperature spikes in the ceramic, which on the whole results in a gentler joining method.

In the event that a kiln process is used to convert the preceramic polymer into an amorphous and/or crystalline ceramic, the joining partners may preferably be protected, at least to a large extent, from too much heat input by using suitable protective mechanisms, for example, insulation materials. For process-engineering reasons, it is advantageous for a liquid preceramic polymer to be used, or, if the preceramic polymer is a solid material, for it to be suspended in a carrier liquid in order to allow for the preceramic polymer to be deposited in the joining region by spraying, dripping, or dipping at least one of the joining partners.

A subject matter of the present invention is also the use of at least one preceramic polymer to join at least two joining partners, of which at least one is a ceramic joining partner. In particular, it is a modified preceramic polymer, in particular, a preceramic that has been modified via an organo-metallic compound. Preferably, the at least one preceramic polymer is used to connect ceramic circuit substrates on metallic modules. By using a preceramic polymer, the heat transfer between the joining partners may be improved by an improved connection to the heat sink (metal), in particular in the case of electronic modules, so that it is possible to dispense with heat-conducting pastes commonly used today and, if applicable, a mechanical fixation. The joining method designed according to the concept of the present invention and/or the use of a preceramic polymer for joining two joining partners allows for the ceramic joining partner (heat source) to be directly connected to a metallic joining partner, for example, in particular a housing or the like (heat sink), which means that costs, for example, for an additional mechanical fixation, may be saved.

### BRIEF DESCRIPTION OF THE SEVERAL VIEWS OF THE DRAWING

FIG. 1 shows in a schematic representation, the sequence of the ceramization of a preceramic polymer.

FIG. 2 shows in a schematic representation, a joining arrangement for fixing two joining partners to each other using a laser beam to heat the preceramic polymer.

### DETAILED DESCRIPTION OF THE INVENTION

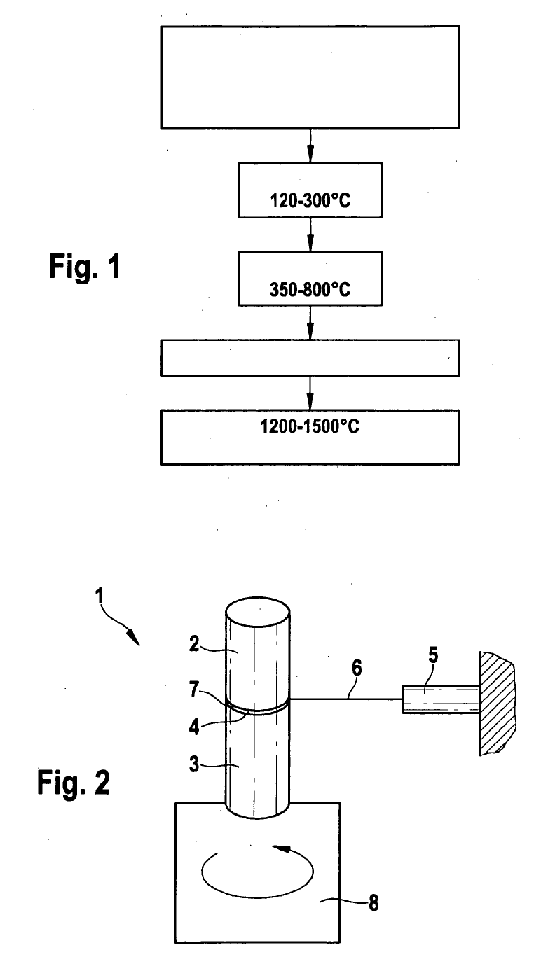

FIG. 1 shows the reaction sequence when heating a preceramic polymer (precursor) between two joining partners, in particular polysilazanes, which are preferably modified by an organo-metallic compound. When the temperature is in a range between approximately 120° C. and approximately 300° C., the preceramic polymer cross-links, so that the joining region is stabilized. In a higher temperature range, between approximately 350° C. and approximately 800° C., the cross-linked preceramic polymer pyrolizes into an amorphous ceramic material of high stability. For applications in which crystalline ceramic material is to be obtained in addition to or as an alternative to the amorphous ceramic material, the joining region must be heated to a temperature from a range between approximately 1200° C. and approximately 1500° C. It falls within the scope of the present invention to adhere to temperature rests in the specified temperature ranges. Alternatively, it is conceivable to heat the joining region directly to the desired temperature to obtain amorphous or crystalline ceramic material.

A possible structure of a joining arrangement 1 (joining device) is shown in FIG. 2. In this instance, a first ceramic joining partner 2 is situated on a second metallic joining partner 3, a layer of preceramic polymer 4 being provided between the joining partners 2, 3. Laser beam source 5 produces a laser beam 6, which is aimed directly onto joining region 7 between joining partners 2, 3. In this exemplary embodiment, laser beam source 5 is disposed in a stationary manner, and joining partners 2, 3 on a rotation device 8, so that thermal energy may be input circumferentially into joining region 7. Additionally or alternatively, it is conceivable to use a laser scanner or a device with which a relatively homogenous energy input may be input along the circumference of joining partners 2, 3.

The use of a laser scanner would also have the advantage that any joining contours could be traced at a high speed by the laser focus.

1-10. (canceled)

11. A method for joining a first ceramic joining partner with at least one second joining partner, comprising:
depositing at least one preceramic polymer on at least one of the first joining partner and the second joining partner in a joining region;
bringing together the first and second joining partners in the joining region; and
heating the joining region to transform the preceramic polymer into at least one of an amorphous and crystalline ceramic connecting the first and second joining partners to each other in a fixed manner.

12. The method as recited in claim 11, wherein the joining region is heated to a temperature in a temperature range between approximately 300° C. and approximately 800° C.

13. The method as recited in claim 11, wherein the joining region is heated to a temperature in a temperature range between approximately 1200° C. and approximately 1500° C.

14. The method as recited in claim 12, wherein one of (a) the preceramic polymer includes at least one polysilazane or (b) the preceramic polymer is formed from at least one polysilazane.

15. The method as recited in claim 13, wherein one of (a) the preceramic polymer includes at least one polysilazane or (b) the preceramic polymer is formed from at least one polysilazane.

16. The method as recited in claim 12, wherein the joining region is heated locally in a temperature-controlled manner using a pyrometer.

17. The method as recited in claim 13, wherein the joining region is heated locally in a temperature-controlled manner using a pyrometer.

18. The method as recited in claim 12, wherein the joining region is heated by laser radiation using a laser scanner.

19. The method as recited in claim 13, wherein the joining region is heated by laser radiation using a laser scanner.

20. The method as recited in claim 12, wherein at least one of a ceramic and metallic material is used as the second joining partner.

21. The method as recited in claim 13, wherein at least one of a ceramic and metallic material is used as the second joining partner.

22. The method as recited in claim 12, wherein the preceramic polymer is deposited at least one of (a) in a liquid form and (b) as a suspension having a carrier liquid.

23. The method as recited in claim 13, wherein the preceramic polymer is deposited at least one of (a) in a liquid form and (b) as a suspension having a carrier liquid.

24. A composite, comprising:
a first ceramic joining partner;
a second joining partner;
a ceramic connector in least one of an amorphous and crystalline form, wherein the ceramic connector connects the first and second joining partners to each other in a joining region, and wherein the ceramic connector is formed by heating a preceramic polymer.
